(19) United States
(12) Patent Application Publication
(10) Pub. No.: US 2010/0307303 A1
(43) Pub. Date: Dec. 9, 2010

(54) Apparatus and method for the slicing of food products

(75) Inventor: Guenther Weber, Gross Nemerow (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Weber Maschinenbau GmbH Breidenbach, Breidenbach (DE)

(21) Appl. No.: 12/791,182

(22) Filed: Jun. 1, 2010

(30) Foreign Application Priority Data
Jun. 3, 2009 (DE) 10 2009 023 729.1

(51) Int. Cl. B26D 7/06

(52) U.S. Cl. 83/13; 83/403.1

(57) ABSTRACT

An apparatus for the slicing of food products has a product feeder which includes a plurality of belt conveyors arranged parallel next to one another. The belt conveyors each include an elastic endless belt serving as a product support for a product to be sliced and they are drivable together in order simultaneously to feed a plurality of products which each lie on one of the belts to a cutting plane in which a cutting blade moves. The belt conveyors have a common drive with a drive shaft. For the setting of an individual single conveying speed for each belt conveyor, a respective setting apparatus is associated with them which is made to individually change the degree of stretching of the belt.

The present invention relates to an apparatus and to a method for the slicing of food products.

Various types of food cutting apparatus are known in the prior art. For example, so-called high-performance slicers are used to slice food products such as meat, sausage or cheese at a high cutting speed. In an endeavor further to increase the cutting performance, such apparatus can have a product feeder which is made to feed a plurality of product loaves or product bars—in the following simply: products—parallel to one another to a common cutting blade which moves in a cutting plane which extends perpendicular to the product conveying direction. It is possible in this manner to utilize a single cutting apparatus—with a correspondingly large blade—for the simultaneous cutting of a plurality of products.

Such a high-performance slicer with independent product feeders for two products to be conveyed in parallel and thus to be sliced simultaneously is described in European patent EP 0 713 753 B1. In this slicer, each product to be sliced is pushed in the direction of the blade by means of a separate driven gripping claw which engages at the rear product end. The gripping claws each have their own drive and can accordingly be driven completely independently of one another at different feed speeds so that it is possible to change the thickness of the cut product slices for the conveyed products by means of the individual product feeder drives independently of one another during the slicing.

Slices with mutually independent product feeder drives for two products to be sliced simultaneously are moreover known from U.S. Pat. No. 3,605,837 and U.S. Pat. No. 3,927,319. Each product is in this respect clamped during the slicing between two oppositely disposed endless belt conveyors which are oriented vertically and which can both hold the product and feed it to a cutting plane at a changeable feed rate. Each pair of endless belt conveyors provided for a respective product has its own drive for the product feeder, with the drives being completely independent of one another so that the product feeder rates of the products to be sliced can be changed independently of one another.

Above all the relatively high effort which is required for the provision of a plurality of mutually independent drives including the associated control devices is problematic with these known apparatus.

It is therefore an object of the invention to simplify the simultaneous slicing of a plurality of food products conveyed in parallel, with the thickness of the cut product slices being able to be changed individually for each product.

The object is satisfied, on the one hand, by an apparatus having the features of claim 1.

The apparatus in accordance with the invention has a product feeder which includes a plurality of belt conveyors which are arranged parallel to one another, which each include an endless belt serving as a product support for a product to be sliced and which can be driven together in order simultaneously to feed a plurality of products which each lie on one of the belts to a cutting plane in which at least one cutting blade moves, in particular in a rotating and/or circulating manner. The belt conveyors have a common drive which includes a drive shaft by which the products lying on the belts can be fed to the cutting plane at a common base conveying speed. The belts are furthermore changeable in length by elastic stretching and circulate in a stretched state so that the individual conveying speed of each belt is dependent not only on the speed of the drive shaft, but also on the degree of stretching of the belt. Each belt has a setting apparatus associated with it which is made to individually change the degree of stretching of the belt and thus its individual conveying speed.

It was recognized in accordance with the invention that with cutting apparatus of the generic kind, products are to be cut up in practice which usually largely coincide with respect to their outer shape and which only vary to a relatively small degree with respect to their cross-sections. In order either to produce individual product slices or portions of product slices of the same weight, the products can therefore substantially be conveyed at the same speed, with only relatively slight adaptations being required for the exact observance of the preset slice weight or portion weight. These adaptations are themselves not only relatively slight for each product, but are also additionally in the same order of magnitude for all products to be sliced simultaneously. The invention utilizes this circumstance.

In accordance with the invention, the construction and manufacturing effort can thus be considerably reduced in that a set of parallel belt conveyors is provided which are driven in common, but which are individually adjustable. For this purpose, a common drive having a drive shaft is provided, with the speed of the drive shaft presetting a common base conveying speed. The precise individual adaptation of the individual conveying speed of each belt conveyor then takes place by an adjustment process at the belt.

In this respect, in accordance with the invention, the fact is utilized that the belt speed is dependent not only on the speed of the drive shaft, but also on the stretching state of the belt at the respective point. The belt speed and thus the product conveying speed of each individual belt can therefore be influenced in that the belt is either further stretched or relaxed by means of a setting apparatus.

Each setting apparatus can be made to change the degree of stretching of the belt by reduction and increasing the size of the running path for the belt. The elastic belt is correspondingly lengthened or shortened by the variation of the running path, whereby the desired belt speed change results with an unchanged speed of rotation of the drive shaft.

In accordance with a further embodiment, each setting apparatus includes a clamping apparatus for the belt. Each of the belts can thus be further tensioned or relaxed individually in order thus to change the individual conveying speed of the belt in a simple manner. If a consideration is made which starts from a degree of stretching of the belt corresponding to the belt speed, a respectively desired deviation from the base conveying speed can be effected by means of the setting apparatus for the belt.

The degree of stretching of each belt is preferably changeable during the slicing operation with a circulating belt. The adaptation of the individual conveying speed can thus take place “online” so-to-say without a delay or interruption of the ongoing cutting operation being necessary. Products having a cross-sectional shape changeable in the longitudinal direction can thus in particular also be sliced while maintaining a uniform slice weight or portion weight, which requires a constant adaptation of the individual conveying speed during the slicing.

In accordance with a further embodiment, it is possible to change the individual conveying speed for every belt by means of the setting apparatus in a range whose limits are determined in that the base conveying speed can be reduced and increased by a specific maximum amount. The respective then current value of the individual conveying speed can therefore vary for each of the belt conveyors by a common value which is given by the base conveying speed. This means with respect to the degree of stretching of the belts that in a base state, which corresponds to the base conveying speed, each of the belts already has a specific pretension so that a sufficient “stretch buffer” is available for a possibly required reduction in the individual conveying speed. The change in the degree of stretching is thus set limits inter alia in that a deflection of the belt, on the one hand, and an overstretching, on the other hand, are to be avoided. The base conveying speed is therefore only changed so-to-say with a relatively small range. The base conveying speed can, for example, be reduced by 20% and can be increased by up to 20%.

The degree of stretching of each belt can in particular be changed in a stepless manner to ensure an exact adaptation of the respective individual conveying speed to the then current circumstances or to the respective requirements.

Each belt is preferably in form-fitted engagement with the drive shaft or with a drive roller which can be driven by the drive shaft. Unwanted slip is avoided by the form-fitted drive. In accordance with an embodiment, each belt is made as a toothed belt. The associated drive shaft or drive roller accordingly has a toothing matching the toothed belt. The toothed arrangement between the drive and the belt provides that the circulating belt is not stretched evenly. The stretching takes place in the free run sections while the degree of stretching is held at the level preset by the toothed arrangement in the active arc of the driver shaft or drive roller. If the belt is considered segment-wise, each belt segment is thus stretched directly on the running off from the drive shaft or drive roller and is accordingly compressed or relaxed for balance in the course of the re-dovetailing. If the belt is stretched more, each point on the belt as a result has to have a longer path to cover then before, which results in a corresponding increase in the belt running speed with an unchanged speed of rotation of the drive shaft. If the degree of stretching is reduced, a reduction in the belt running speed results accordingly.

To avoid a skipping of teeth and to ensure a secure form fit between the drive and the toothed belt, each belt can be held by a pressing device, in particular one or more pressing rollers, in engagement with the drive shaft or with a drive roller drivable by the drive shaft.

In accordance with a further embodiment, each setting apparatus can include at least one adjustable clamping roller, with the clamping roller preferably being adjustable substantially at right angles to a product conveying device. The setting of the clamping roller can in this respect take place by a setting device provided for this purpose. To avoid any unwanted influencing of the upper run of the belt conveyor serving as a product support, the clamping roller is preferably arranged at the lower run of the belt conveyor. The tension of the belt and thus its degree of stretching can be set fast and exactly by a clamping roller.

In accordance with a further embodiment of the invention, each belt has an upper belt associated with it which is made to act on the upper side of the product. Such an additional belt can even be made without a drive and only free-running so that the upper belt unit exerts a holding-down function, whereby a particularly reliable product positioning, product holding, or product guidance is achieved during the slicing. The product to be sliced is therefore so-to-say clamped between two circulating belts disposed opposite one another and are conveyed in this manner. It is also possible that each upper belt is drivable and in this respect can be synchronized with its lower belt and, that is its “partner belt” serving as a product support. The product is then conveyed, as in the initially named prior art in this respect, by the lower belt and the upper belt together.

This object is satisfied, on the other hand, by a method having the features of claim 14.

In the method in accordance with the invention for the slicing of food products, a plurality of products which each lie on one of the belts are supplied simultaneously to a cutting plane in which at least one cutting blade is moved, in particular in a rotating and/or circulating manner, by means of a product feeder which includes a plurality of belt conveyors which are arranged in parallel next to one another and which each include an endless belt serving as a product support for a product to be sliced, with the belts being changeable in length by elastic stretching and circulating in a stretched state. The belts are individually driven by means of a common drive and the degree of stretching of each belt and thus its individual conveying speed us changed individually as required in order to set the thickness of product slices to be cut individually for each product.

In accordance with an embodiment, the degree of stretching of each belt is changed in dependence on the contour of the product, with the contour of the product preferably being determined using a detection device integrated into the apparatus. As soon as a product region with a reduced cross-sectional surface, for example, therefore moves to the cutting plane on the slicing of the product, the individual conveying speed of the respective belt conveyor is increased by a corresponding amount so that as a result the product slice weight remains unchanged. The cutting apparatus is aware of the topography of the product and thus of the contour extent of the product in the conveying direction, so that it is also known when which product cross-sectional surface arrives at the cutting plane so that a respective desired slice thickness can be produced by corresponding control of the setting apparatus, and indeed—if desired—with a slice thickness varying from slice to slice. The principle of the direct change of the product feeder in dependence on the product contour is known per se so that this should not be looked at in any more detail.

The invention will be described in the following by way of example with reference to the drawing.

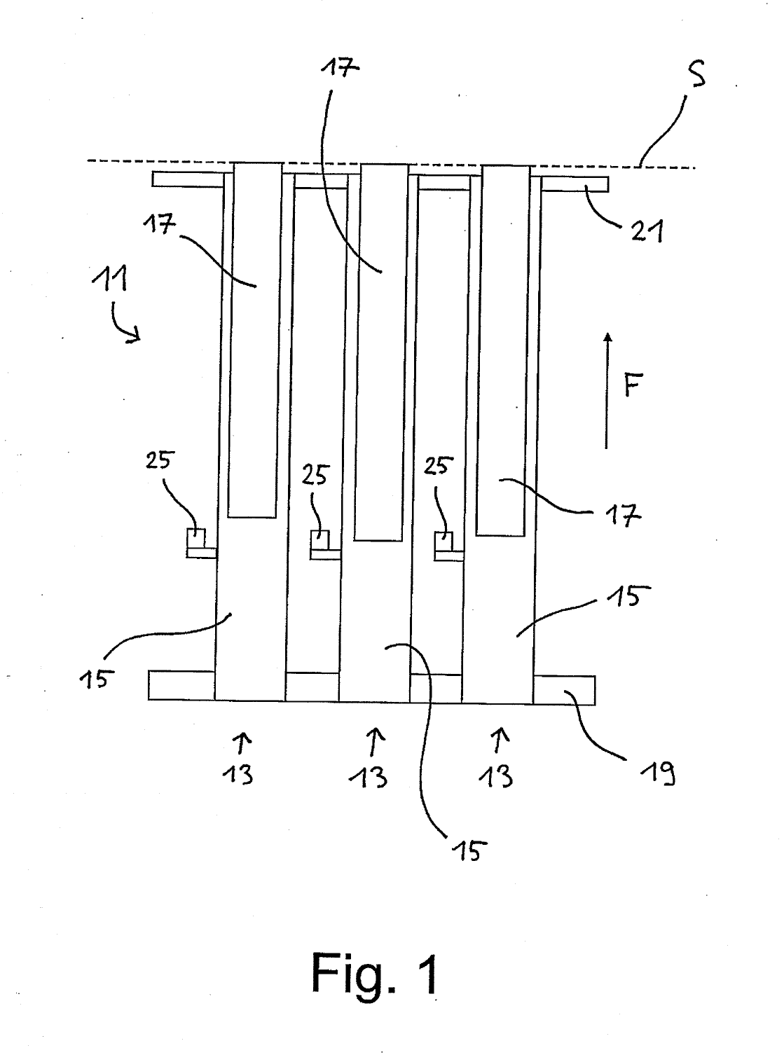

FIG. 1 schematically shows a plan view of the product feeder region of a cutting apparatus in accordance with the invention;

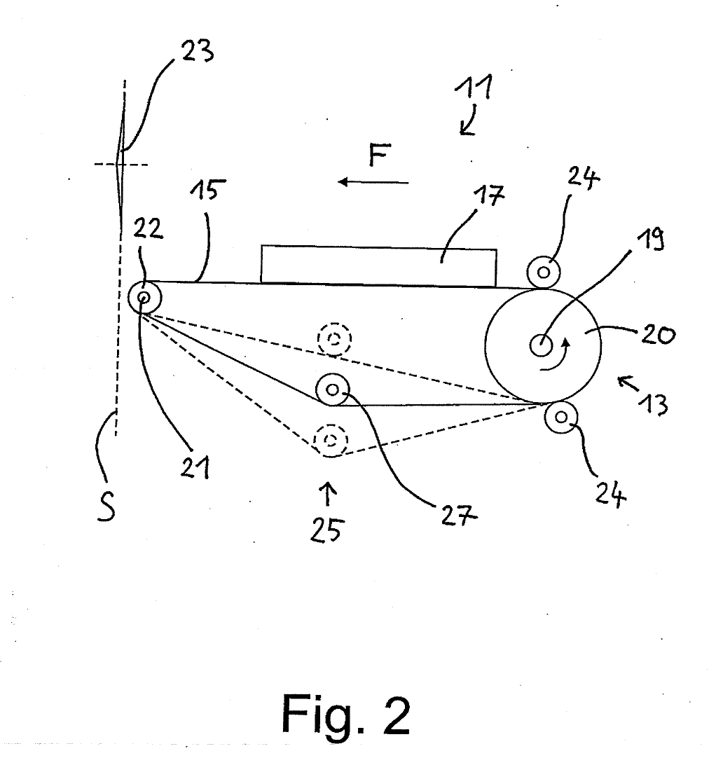

FIG. 2 schematically shows a side view of the cutting apparatus in accordance with FIG. 1; and

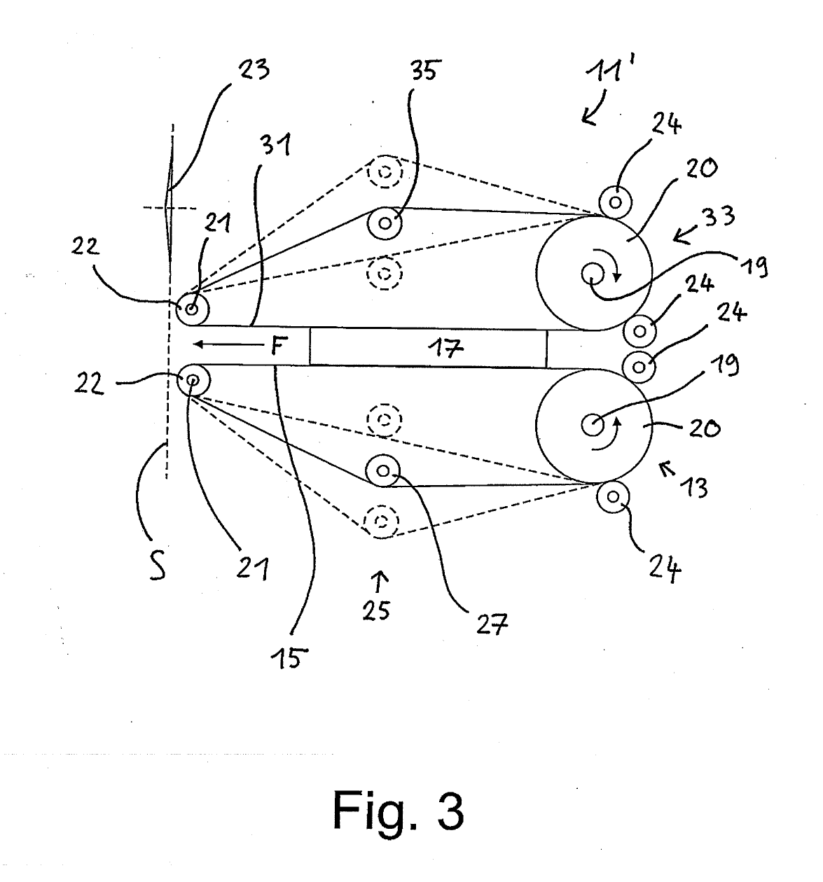

FIG. 3 schematically shows a side view of a cutting apparatus in accordance with an alternative embodiment of the invention.

The cutting apparatus in accordance with the invention includes a product feeder 11 with, in this example, three belt conveyors 13 arranged next to one another and aligned parallel to one another. Each of the belt conveyors 13 includes an endless belt 15 which serves as a support for a product 17 to be sliced. The belts 15 are driven by a common drive shaft 19 on which drive rollers 20 (FIG. 2) are seated in a rotationally fixed manner. The belts 15 furthermore run around a return shaft 21 having return rollers 22 (FIG. 2), with the return shaft 21 being arranged close to a cutting plane S. A cutting blade 23 (FIG. 2) rotates in a planetary manner in the cutting plane S, with alternatively a cutting blade, in particular a scythe blade, also being able to be used which does not rotate in a planetary manner, but rather only rotates. The return rollers 22 can also be journalled separately instead of on the common return shaft 21.

The products 17 lying on the upper run of the belt conveyer 13 are fed simultaneously and parallel to one another along a product conveying direction F to the cutting plane S by driving the drive rollers 20 by means of the common drive shaft 19.

The drive of the drive rollers 20 does not have to take place directly by a common coaxial drive shaft 19. Depending on the embodiment, it is e.g. also possible that different transmission components are provided as an intermediate member between the drive shaft 19 and the respective drive roller 20. The drive shaft 19, however, ultimately represents a common drive for all belt conveyors 13.

The belts 15 are made as elastically stretchable toothed belts, i.e. changeable in length, and are in form-fitted engagement with the respective drive roller 20. For simplification, the toothed arrangements of the belt 15 and of the drive roller 20 are not shown in FIG. 2. To reliably avoid a drive slip, two respective drive rollers 24 press the belt 15 toward the drive roller 20.

Each of the belts 15 has a setting apparatus 25 associated with it by means of which the respective belt 15 can either be stretched to a greater length or can be relaxed in the sense of a length reduction. In a base state of the product feeder 11, all the belts 15 circulate at a common base conveying speed in the stretched state so that all the products are “of the same speed” and the thickness of the cut product slices is the same for all belt conveyors 13. Since the individual conveying speed of the belt conveyors 13 also depends on the degree of stretching of the respective belt 15 as well as on the speed of rotation of the drive shaft 19, the individual conveying speed of each belt conveyor 13 at the belts 15 can be either increased or decreased with respect to the value of the base conveying speed by controlling the setting apparatus 25 and by changes in the degree of stretching effected thereby, that is deviations from the mentioned base state. This individual variation of the individual conveying speeds of the belts 15 takes place despite the common drive of the belts 15 by the common drive shaft 19 rotating at a constant speed. Since a separate setting apparatus 25 is associated with each belt conveyor 13, the individual conveying speeds can be varied individually.

The individual setting of the individual conveying speeds by a different position of the products 17 with respect to the cutting plane S is illustrated in FIG. 1, with it being assumed for better understanding that the products 17 originally had the same lengths. Accordingly, the product 17 located at the left in FIG. 1 instantaneously runs ahead of the other products so that it instantaneously has the smallest residual length. Since the cutting blade 23 (FIG. 2) cuts through all supplied products 17 with a constant cutting frequency, the product slices cut from the products 17 are the thicker, the higher the individual conveying speed of the respective belt conveyer 13 is instantaneously.

The underlying mechanism of the setting apparatus 25 will be explained more exactly with reference to FIG. 2. Each belt conveyor 13 has a clamping roller 27 associated with it which is arranged at the lower run of the belt conveyor 13 and can be adjusted upwardly and downwardly at right angles to the product conveying direction F by means of a setting drive. The position of the clamping roller 27 shown by solid lines in this respect corresponds to the above-mentioned base state in which the belt 15 circulates at a predetermined degree of stretching. The degree of stretching of the belt 15 can be increased with respect to the degree of stretching of the base state by adjustment of the clamping roller 27 into the lower position shown by a broken line. Such an increase in the degree of stretching effects an increase in the belt speed and thus in the individual conveying speed of the belt conveyor 13 relative to the base conveying speed. In an analog manner, the degree of stretching of the belt 15 can be reduced with respect to the degree of stretching of the base state by adjustment of the clamping roller 27 into the upper position likewise shown by a dashed line, whereby a corresponding reduction in the individual conveying speed of the belt conveyor 13 relative to the base conveying speed is effected.

Overall, therefore, an individual change in the individual conveying speed of each of the belt conveyors 13 within a range extending around the base conveying speed is made possible. The adjustment range is given by the respective maximum positions of the clamping roller 27 and is in particular determined by the elastic properties of the belt 15. The variation range of the individual conveying speed is defined, for example, by an increase and a decrease in the base conveying speed by a maximum in each case of 20%. This variation range is sufficient for practice since normally such products 17 are to be conveyed and sliced simultaneously on the individual belt conveyors 13 which only differ with respect to their outer contours, in particular with respect to the extent of their cross-sectional surfaces in the longitudinal direction, to a degree such that, for the achieving of weight-constant slices or portions, a variation of the slice thickness required for this purpose can be achieved by comparatively small relative individual conveying speed changes.

If a greater adaptation of the belt running speed should be necessary due to the properties of the products to be sliced than can be effected by the maximum possible adjustment stroke of the clamping rollers 27, it is possible at all times so-to-say to realize a common offset or a common base state shift for all belt conveyors 13 directly via the common drive, e.g. in the embodiment set forth here by an increase or decrease in the speed of rotation of the drive shaft 19.

FIG. 3 shows an alternative embodiment of the invention. In the product feeder 11′, each belt 15 has a belt 31 associated with it which acts on the supper side of the product 17 and thus provides a more reliable product guidance during the conveying process. The product 17 to be conveyed is clamped between the oppositely disposed belts 15, 31. The upper belt 31 is associated with an upper belt conveyor 33 which is designed analogously to the lower belt conveyor 13 and likewise includes an adjustable clamping roller 35. So that the running speed of the two runs feeding the product 17 together is the same, the upper belt conveyor 33 is driven synchronously to the lower belt conveyor 33, with the synchronization in particular being achieved in that the upper clamping roller 35 is always adjusted on an adjustment of the lower clamping roller 27 by the same amount in the opposite direction. This can be achieved either by means of a correspondingly controlled separate adjustment drive or by a suitable mechanical coupling of the two clamping rollers 27, 35. The two drive shafts 19 are accordingly also synchronized.

Provision can alternatively be made that the upper belt conveyor 33 does not have a drive and the upper belt 31 only circulates freely.

Since, in accordance with the invention, the individual conveying speeds are individually adjustable, the thicknesses of the cut product slices are adapted individually for each belt conveyor 13 without a separate drive having to be provided for each belt conveyor 13 for this reason. The effort and the costs for the provision of the product feeder 11 in accordance with the invention and thus of the total slicer can thus be reduced. A constant slice weight or portion weight can in particular be ensured for all simultaneously supplied products 17 despite product cross-sectional surfaces varying in the longitudinal product direction.

### REFERENCE NUMERAL LIST

11, 11′ product feeder
13 belt conveyor
15 belt
17 product
19 drive shaft
20 drive roller
21 return shaft
22 return roller
23 cutting blade
24 pressing roller
25 adjustment apparatus
27 clamping roller
31 upper belt
33 upper belt conveyor
35 upper clamping roller
S cutting plane
F product conveying direction

1. An apparatus for the slicing of food products, in particular a high-performance slicer, comprising
a product feeder (11, 11′) which includes a plurality of belt conveyors (13) which are arranged parallel to one another, which each include an endless belt (15) serving as a product support for a product (17) to be sliced and which can be driven together in order simultaneously to feed a plurality of products (17) which each lie on one of the belts (15) to a cutting plane (S) in which at least one cutting blade (23) moves, in particular in a rotating and/or circulating manner,
wherein the belt conveyors (13) have a common drive which includes a drive shaft (19) by which the products (17) lying on the belts (15) can be fed to the cutting plane (S) at a common base conveying speed;
wherein the belts (15) are changeable in length by elastic stretching and circulate in a stretched state so that the individual conveying speed of each belt (15) is dependent not only on the speed of the drive shaft (19), but also on the degree of stretching of the belt; and
wherein each belt (15) has a setting apparatus (25) associated with it which is made to individually change the degree of stretching of the belt (15) and thus its individual conveying speed.

2. An apparatus in accordance with claim 1, characterized in that each setting apparatus (25) is made to change the degree of stretching of the belt (15) by decreasing and increasing the running path for the belt (15).

3. An apparatus in accordance with claim 1, characterized in that each setting apparatus (25) includes a clamping apparatus for the belt (25).

4. An apparatus in accordance with claim 1, characterized in that the degree of stretching of each belt (15) is changeable during the slicing operation with a circulating belt (15).

5. An apparatus in accordance with claim 1, characterized in that, for each belt (15), its individual setting speed is changeable by means of the setting apparatus (25) in a range whose limits are determined in that the base conveying speed can be decreased and increased by a specific maximum degree.

6. An apparatus in accordance with claim 5, characterized in that the base conveying speed can be decreased by up to 20% and can be increased by up to 20%.

7. An apparatus in accordance with claim 1, characterized in that the degree of stretching of each belt (15) can be changed in a stepless manner.

8. An apparatus in accordance with claim 1, characterized in that each belt (15) is in form-fitted engagement with the drive shaft (19) or with a drive roller (20) drivable by the drive shaft (19).

9. An apparatus in accordance with claim 1, characterized in that each belt (15) is made as a toothed belt.

10. An apparatus in accordance with claim 1, characterized in that each belt (15) is in engagement with the drive shaft (19) or with a drive roller (20) drivable by the drive shaft (19) by a pressing device (24), in particular by one or more pressing rollers (24).

11. An apparatus in accordance with claim 1, characterized in that each setting device (25) includes at least one adjustable clamping roller (27), with the clamping roller (27) preferably being adjustable substantially at right angles to a product conveying direction (F).

12. An apparatus in accordance with claim 1, characterized in that each belt (15) has associated an upper belt (31) with it which is made to act on the upper side of the product (17).

13. An apparatus in accordance with claim 1, characterized in that each upper belt (31) is drivable and can be synchronized with a belt (15) serving as a product support.

14. A method for the slicing of food products, wherein
a plurality of products (17) which each lie on a respective belt (15), are simultaneously fed by means of a product feeder (11, 11′) to a cutting plane (S) in which at least one cutting blade (23) moves, in particular in a rotating and/or circulating manner;
wherein the product feeder includes a plurality of belt conveyors (13) which are arranged parallel to one another and which in each case include an endless belt (15) serving as a product support for a product (17) to be sliced, with the belts (15) being changeable in length by elastic stretching and circulating in a stretched state
the belts (15) are driven by means of a common drive, in particular a drive including a common drive shaft (19) for the belts (15); and
the degree of stretching of each belt (15) and thus its individual conveying speed is individually changed as required to set the thickness of product slices to be cut individually for each product (17).

15. A method in accordance with claim 14, characterized in that the degree of stretching of each belt (15) is changed in dependence on the contour of the product (17), with the contour of the product (17) preferably being determined using a detection device integrated into the apparatus.
